(19) United States
(12) Patent Application Publication
(10) Pub. No.: US 2010/0088084 A1
(43) Pub. Date: Apr. 8, 2010

(54) METHOD FOR TRANSLATING A NON-VERBAL COMMUNICATION WITHIN A VIRTUAL WORLD ENVIRONMENT

(75) Inventors: Randy S. Johnson, O Fallon, MO (US); Geetika Tandon, Silver Spring, MD (US); Wendy Ark, San Diego, CA (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/245,433

(22) Filed: Oct. 3, 2008

(51) Int. Cl. G06F 17/28

(52) U.S. Cl. 704/2

(57) ABSTRACT

The present disclosure is directed to a method for translating non-verbal communication in a virtual world environment. The method may comprise: receiving a first signal comprising a first non-verbal communication associated with an avatar within the virtual world environment having a first meaning within a first context; determining a second meaning for the first non-verbal communication within a second context; translating the first non-verbal communication to a second non-verbal communication when the first meaning is at least substantially different from the second meaning; providing at least one of the first non-verbal communication and the second non-verbal communication to a user within the second context, wherein the at least one of the first non-verbal communication and the second non-verbal communication are selected for providing the second user with a non-verbal communication at least substantially conveying the first meaning; and alerting the first user of the substantially different meaning.

### TECHNICAL FIELD

The present disclosure generally relates to the field of non-verbal communication translation, and more particularly to a method to enable non-verbal communication to be translated in a virtual world in a similar fashion as spoken/written language translation.

### BACKGROUND

In a virtual world, just as in the real world, communication is greater than language alone. Types of non-verbal communication include gestures, facial expressions, posture, dress/clothing, physical inter-personal distance, body movements, eye behavior (i.e. eye contact, eye movement, etc), and conversational cadence. However, a non-verbal sign may hold one meaning in one culture, while the same non-verbal sign may hold another meaning in another culture. These differences in non-verbal communication arise from the diversity of accepted norms in groups with different cultural, regional, or generational upbringings. When two or more people of different cultures interact in a virtual world, not only does the language need to be translated, but also the body language. The problem today is that non-verbal communication is not translated within a virtual world setting, possibly leading to confusion and mixed messages.

### SUMMARY

The present disclosure is directed to a method for translating non-verbal communication in a virtual world environment. The method may comprise: receiving a first signal from a first user comprising a first non-verbal communication associated with an avatar within the virtual world environment having a first meaning within a first context; determining a second meaning for the first non-verbal communication within a second context; translating the first non-verbal communication to a second non-verbal communication when the first meaning is at least substantially different from the second meaning; providing at least one of the first non-verbal communication and the second non-verbal communication to a second user within the second context, wherein the at least one of the first non-verbal communication and the second non-verbal communication are selected for providing the second user with a non-verbal communication at least substantially conveying the first meaning; and providing the second meaning to the first user for alerting the first user to the second meaning within the second context when the first meaning is at least substantially different from the second meaning.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating the basic steps for a method for translating non-verbal communication within a virtual world environment.

### DETAILED DESCRIPTION

Reference will now be made in detail to the subject matter disclosed, which is illustrated in the accompanying drawings.

The present disclosure is directed to a method for translating non-verbal communication in a virtual world environment. The method may comprise: receiving a first signal from a first user comprising a first non-verbal communication associated with an avatar within the virtual world environment having a first meaning within a first context; determining a second meaning for the first non-verbal communication within a second context; translating the first non-verbal communication to a second non-verbal communication when the first meaning is at least substantially different from the second meaning; providing at least one of the first non-verbal communication and the second non-verbal communication to a second user within the second context, wherein the at least one of the first non-verbal communication and the second non-verbal communication are selected for providing the second user with a non-verbal communication at least substantially conveying the first meaning; and providing the second meaning to the first user for alerting the first user to the second meaning within the second context when the first meaning is at least substantially different from the second meaning.

This invention may comprise of the following components:
Virtual World Supervisor—The Virtual World Supervisor may be an overall control program of the virtual world environment.
Virtual World Language Translator—The Virtual World Language Translator may be an add-on program, such as Babbler (from http://www.maxcase.info/?p=563), that provides language translation.
Non-Verbal Communication Comparison Engine—The Non-Verbal Communication Comparison Engine may be used to determine if the speaker and the recipient's non-verbal communications are different. A required translation database may also exist.
Non-Verbal Communication Translator—The Non-Verbal Communication Translator may be used to translate non-verbal communication to the recipient's culture. The speaker is notified of the translation for information purposes, and the recipient is also alerted so that both are aware of the translation.
Non-Verbal Communication Translation Database—The Non-Verbal Communication Translation Database may contain all of the culture translation databases used by the Non-Verbal Communication Translator.

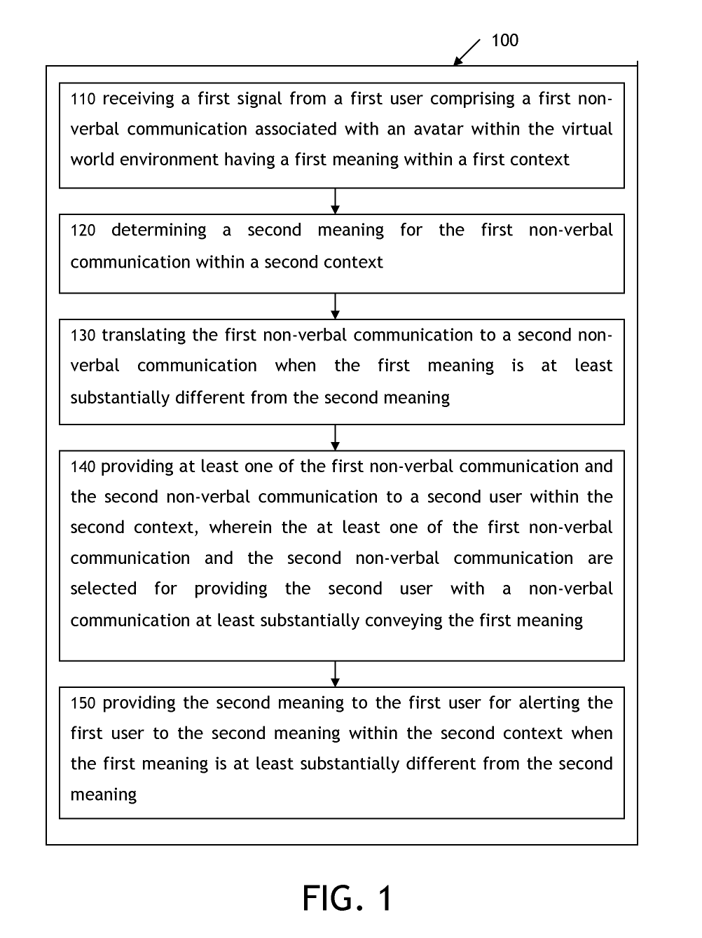

FIG. 1 depicts one potential embodiment's program flow using Non-Verbal Communication translation in a virtual world:
Step 1: Speaker may initiate communication with one or more other users.
Step 2: The profile of the speaker may be compared to each recipient's profile to determine if there are differences that require translation.
Step 3: If differences exist, determining whether a translation database for the differences exist. If no translation database exists, standard methods of communication may be followed (Step 10). If a translation database exists, the speaker may be presented with the option to enable/disable Non-Verbal Communication (NVC) Translator (Step 4).
Step 4: The speaker may be provided with the option to enable or disable the NVC Translator. Optionally, this could be set in the user profile as enabled, disabled, or prompt.
Step 5: If the NVC Translator is requested, the NVC Translator may be enabled and may monitor non-verbal communication activities (Step 6). If the NVC Translator is not requested, standard methods of communication may be followed (Step 10).
Step 6: The speaker may issue a verbal and a non-verbal communication. For example, Hi Joe! /Smile.
Step 7: The NVC Translator may capture the non-verbal communication. Using the NVC translation database, the non-verbal communication may be translated into the desired context of the non-verbal communication.
Step 8: The recipient may receive the translated non-verbal communication along with the verbal communication. The recipient may be alerted that the non-verbal communication is a translated non-verbal communication so not to be possibly misinterpreted.
Step 9: The speaker may also be provided the translation for awareness and training. This may assist in future real-life communication to avoid miscommunication.
Step 10: The speaker has not requested non-verbal communication translation, or the speaker to recipient non-verbal communication translation database does not exist, so the non-verbal communication is not translated.

FIG. 1 depicts a flow diagram illustrating the steps performed by a non-verbal communication translator within a virtual world environment method 100 in accordance with the present disclosure. Step 110 may receive a first signal from a first user comprising a first non-verbal communication associated with an avatar within the virtual world environment having a first meaning within a first context. Step 120 may determine a second meaning for the first non-verbal communication within a second context. Step 130 may translate the first non-verbal communication to a second non-verbal communication when the first meaning is at least substantially different from the second meaning. Step 140 may provide at least one of the first non-verbal communication and the second non-verbal communication to second a user within the second context, wherein the at least one of the first non-verbal communication and the second non-verbal communication are selected for providing the second user with a non-verbal communication at least substantially conveying the first meaning. Step 150 may provide the second meaning to the first user for alerting the first user to the second meaning within the second context when the first meaning is at least substantially different from the second meaning.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A computer program product for translating non-verbal communication within a virtual world environment, the method comprising:
a tangible computer useable medium having computer useable code tangibly embodied therewith, the computer useable program code comprising:
computer program code configured to receiver a first signal from a first user comprising a first non-verbal communication associated with an avatar within the virtual world environment, the first non-verbal communication having a first meaning within a first context;
computer program code configured to determine a second meaning for the first non-verbal communication within a second context;
computer program code configured to translate the first non-verbal communication to a second non-verbal communication when the first meaning is different from the second meaning; and
computer program code configured to provide at least one of the first non-verbal communication and the second non-verbal communication to a second user within the second context, wherein the at least one of the first non-verbal communication and the second non-verbal communication are selected for providing the second user with a non-verbal communication conveying the first meaning; and
computer program code configured to provide the second meaning to the first user for alerting the first user to the second meaning within the second context only when the first meaning is different from the second meaning.
